(19) United States
(12) Patent Application Publication
(10) Pub. No.: US 2016/0321700 A1
(43) Pub. Date: Nov. 3, 2016

(54) INTERACTIVE CONTENT- BASED INFORMATION DISTRIBUTION TO A SELECT AUDIENCE GROUP

(71) Applicant: International Business Machines Corporation, Armonk, NY (US)

(72) Inventors: Aya R. A. Elgebeely, 6th of October (EG); Hisham E. El-Shishiny, Cairo (EG); Muhammed M. F. Moussa, Riyadh (SA)

(21) Appl. No.: 14/970,871

(22) Filed: Dec. 16, 2015

Related U.S. Application Data
(63) Continuation of application No. 14/701,719, filed on May 1, 2015.

(51) Int. Cl. G06Q 30/02; H04L 29/08

(52) U.S. Cl. CPC G06Q 30/0267; H04L 67/306; G06Q 30/0269

(57) ABSTRACT

A manner of tailoring an information distribution to an individual such that the individual is a member of a select audience group for the information-distribution is provided. Based on a set of information-distribution categories, the interests of an individual and the content of an information-distribution are matched to increase the effectiveness of the information-distribution.

### BACKGROUND

The present invention relates generally to the field of information distribution, and more particularly to content-based information distribution.

A variety of people and organizations seek to distribute information to a select audience group. One example of such an organization is an advertiser. For an advertiser, the select audience group comprises a set of individuals most likely to use or want the advertised goods or services. In order to reach a desired number of individuals in this select audience group, an advertiser must overexpose other individuals to an advertisement. In addition, based on the medium and format of the advertisement, an advertiser is unable to reach some individuals in the select audience group. Other examples of such people and organizations seeking to distribute information are: politicians, news entities, and entertainers.

An example of one medium that both overexposes individuals not in the select audience group and underexposes individuals in the select audience group is an advertisement on a billboard next to a highway. An individual who is not a member of the select audience group will see the billboard when passing that stretch of highway. However, an individual with a visual impairment who is a member of the select audience group is unable to appreciate the advertisement. Additionally, an individual who is a member of the select audience group may not look at the advertisement because the individual is driving.

### SUMMARY

According to an aspect of the present invention, there is a method, computer program product, and/or system that performs the following steps (not necessarily in the following order): (i) creating an information-distribution profile; (ii) creating a user profile; (iii) receiving a subset of the information-distribution profile; (iv) confirming a category match; (v) presenting an information-distribution content in a human understandable format; and (vi) receiving an information-distribution response. The information-distribution profile comprises at least: a first set of information-distribution categories, the information-distribution content, and a set of response options. The user profile comprises at least a second set of information-distribution categories. The category match exists if at least a subset of the first set of information-distribution categories is also a subset of the second set of information-distribution categories. At least the confirming step is performed by computer software running on computer hardware.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram view of a machine logic (for example, software) portion of the first embodiment system;

FIG. 4 is a block diagram view of a second embodiment of a system according to the present invention; and

FIG. 5 is a block diagram view of an apparatus used to implement one or more steps of a third embodiment of a system according to the present invention.

### DETAILED DESCRIPTION

A manner of tailoring information distribution to an individual such that the individual is a member of a select audience group for the information-distribution is provided. Based on a set of information-distribution categories, the interests of an individual and the content of an information-distribution are matched to increase the effectiveness of the information-distribution. This Detailed Description section is divided into the following sub-sections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

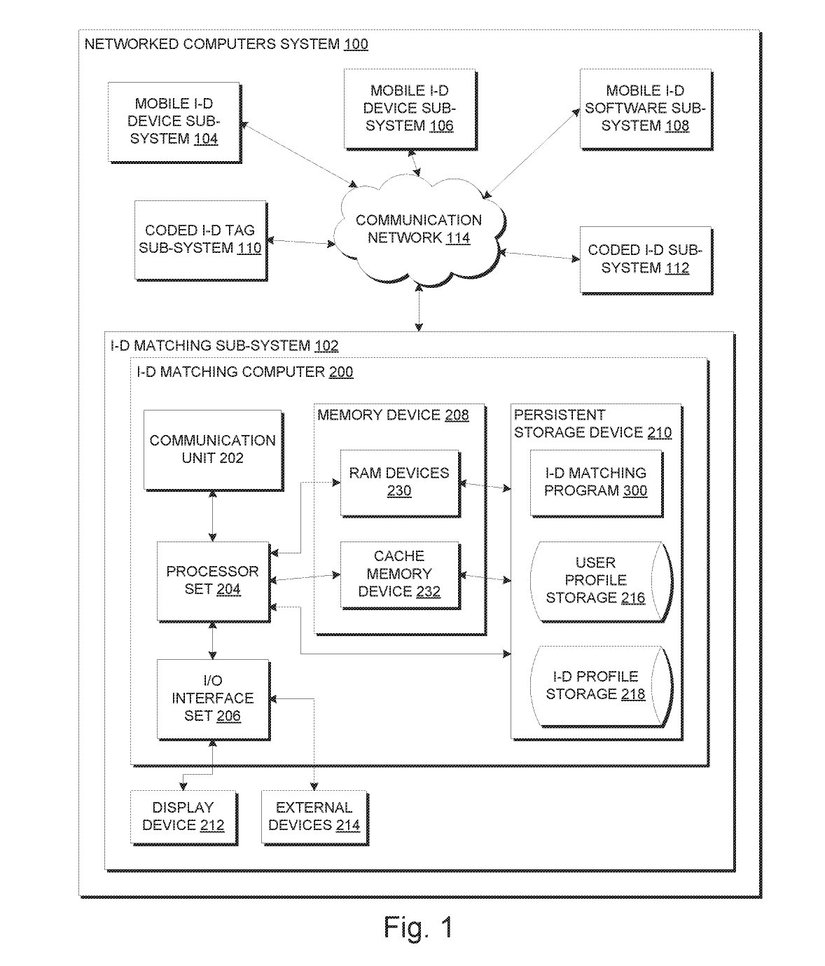

An embodiment of a possible hardware and software environment for software and/or methods according to the present invention will now be described in detail with reference to the Figures. FIG. 1 is a functional block diagram illustrating various portions of networked computers system 100, including: information-distribution (I-D) matching sub-system 102; mobile information-distribution (I-D) device sub-systems 104, 106; mobile information-distribution (I-D) software sub-system 108; coded information-distribution (I-D) tag sub-system 110; coded information-distribution (I-D) sub-system 112; communication network 114; information-distribution (I-D) matching computer 200; communication unit 202; processor set 204; input/output (I/O) interface set 206; memory device 208; persistent storage device 210; display device 212; external devices 214; user profile storage 216; information-distribution (I-D) profile storage 218; random access memory (RAM) devices 230; cache memory device 232; and information-distribution (I-D) matching program 300.

I-D matching sub-system 102 is, in many respects, representative of the various computer sub-system(s) in the present invention. Accordingly, several portions of I-D matching sub-system 102 will now be discussed in the following paragraphs.

I-D matching sub-system 102 may be a laptop computer, tablet computer, netbook computer, personal computer (PC), a desktop computer, a personal digital assistant (PDA), a smart phone, or any programmable electronic device capable of communicating with the client sub-systems via communication network 114. I-D matching program 300 is a collection of machine readable instructions and/or data that is used to create, manage and control certain software functions that will be discussed in detail, below, in the Example Embodiment sub-section of this Detailed Description section.

I-D matching sub-system 102 is capable of communicating with other computer sub-systems via communication network 114. Communication network 114 can be, for example, a local area network (LAN), a wide area network (WAN) such as the Internet, or a combination of the two, and can include wired, wireless, or fiber optic connections. In general, communication network 114 can be any combination of connections and protocols that will support communications between server and client sub-systems.

I-D matching sub-system 102 is shown as a block diagram with many double arrows. These double arrows (no separate reference numerals) represent a communications fabric, which provides communications between various components of I-D matching sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory device 208 and persistent storage device 210 are computer-readable storage media. In general, memory device 208 can include any suitable volatile or non-volatile computer-readable storage media. It is further noted that, now and/or in the near future: (i) external devices 214 may be able to supply, some or all, memory for I-D matching sub-system 102; and/or (ii) devices external to I-D matching sub-system 102 may be able to provide memory for I-D matching sub-system 102.

I-D matching program 300 is stored in persistent storage device 210 for access and/or execution by one or more processors of processor set 204, usually through memory device 208. Persistent storage device 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage device 210.

I-D matching program 300 may include both machine readable and performable instructions and/or substantive data (that is, the type of data stored in a database). In this particular embodiment, persistent storage device 210 includes a magnetic hard disk drive. To name some possible variations, persistent storage device 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage device 210 may also be removable. For example, a removable hard drive may be used for persistent storage device 210. Other examples include optical and magnetic disks, thumb drives, and smart cards that are inserted into a drive for transfer onto another computer-readable storage medium that is also part of persistent storage device 210.

Communication unit 202, in these examples, provides for communications with other data processing systems or devices external to I-D matching sub-system 102. In these examples, communication unit 202 includes one or more network interface cards. Communication unit 202 may provide communications through the use of either or both physical and wireless communications links. Any software modules discussed herein may be downloaded to a persistent storage device (such as persistent storage device 210) through a communications unit (such as communication unit 202).

I/O interface set 206 allows for input and output of data with other devices that may be connected locally in data communication with I-D matching computer 200. For example, I/O interface set 206 provides a connection to external devices 214. External devices 214 will typically include devices such as a keyboard, keypad, a touch screen, and/or some other suitable input device. External devices 214 can also include portable computer-readable storage media such as, for example, thumb drives, portable optical or magnetic disks, and memory cards. Software and data used to practice embodiments of the present invention, for example, I-D matching program 300, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

### II. Example Embodiment

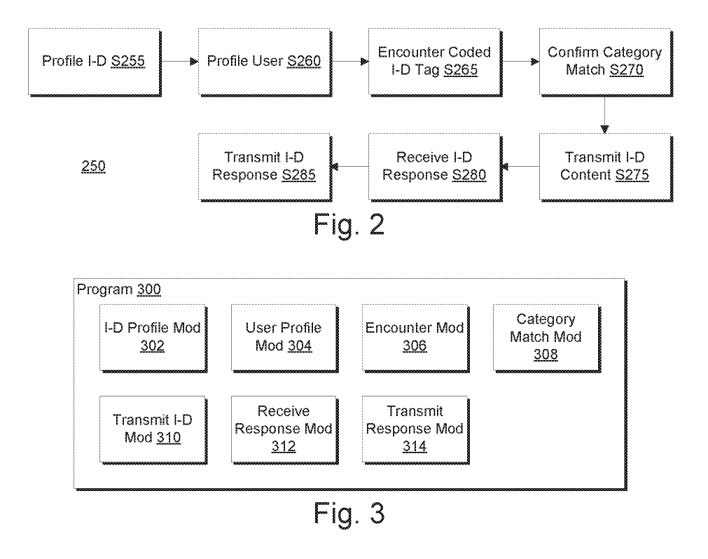

FIG. 2 shows flowchart 250 depicting a method according to the present invention. FIG. 3 shows I-D matching program 300 which performs at least some of the method steps of flowchart 250. This method and associated software will now be discussed, over the course of the following paragraphs, with extensive reference to FIG. 2 (for the method step blocks) and FIG. 3 (for the software blocks). In this example, a user, Able, carries mobile I-D device sub-system 104 (FIG. 1) and encounters an information-distribution (I-D) for a company, BCD Corp, bearing coded I-D tag sub-system 110 (FIG. 1).

Processing begins at step S255, where information-distribution (I-D) profile module (“mod”) 302 profiles an I-D. Upon profiling an I-D, an I-D profile is created and stored within I-D profile storage 218 (FIG. 1). Alternatively, the I-D profile is not stored in a set location. The I-D profile contains a set of information describing the I-D. The I-D profile may include, but is not limited to: (i) a unique I-D identification code; (ii) a company name; (iii) a company identification code; (iv) an I-D content; (v) an I-D campaign date range; (vi) a set of I-D categories into which the I-D fits; (vii) a set of response options; (viii) a set of metadata; (ix) an expiration date; and/or (x) a set of I-D identification codes corresponding to a set of related I-Ds. In some embodiments of the present invention, the set of I-D categories are selected from a predetermined list; for example, the predetermined list may include, but is not limited to: sports, movies, television, concerts, food, toys, airlines, and/or hotels. Alternatively, the set of I-D categories are determined in an ad-hoc fashion. In some embodiments of the present invention, the set of information contained in the I-D profile is input: (i) by a service provider; (ii) by an information distributor; and/or (iii) automatically. In some embodiments of the present invention, a set of coded I-D tags encoded with a subset of the I-D profile are provided. Alternatively, the I-D is encoded with a subset of the I-D profile. In this example, BCD Corp. presents an advertisement for a cruise package. The I-D profile includes: (i) the unique I-D identification code, BCDCORP1; (ii) the I-D content; (iii) a set of I-D categories, including travel, vacation, and cruise; and (iv) the set of response options, including “contact” and “do not contact.” BCD Corp. is provided coded I-D tag sub-system 110 to place on the I-D. Coded I-D tag sub-system 110 is encoded with the unique I-D identification code.

Processing proceeds to step S260, where user profile mod 304 profiles a user. In some embodiments of the present invention, I-D matching sub-system 102 profiles a user by creating a user profile and storing the user profile within user profile storage 216 (FIG. 1). Alternatively, the user profile is not stored in a set location. The user profile contains a set of information describing a set of preferences of the user. The user profile may include, but is not limited to: (i) a unique user identification code; (ii) a name; (iii) a set of I-D categories for which the user desires to receive I-D content; (iv) a set of biometric identification information; (v) a password; (vi) a set of contact information; (vii) preferred method of I-D content presentation (e.g., audio); (viii) age and/or birthdate; and/or (ix) biographical information (e.g., population demographics). In some embodiments of the present invention, the set of information contained in the I-D profile is input: (i) by a service provider; and/or (ii) by a user. In some embodiments of the present invention, a device encoded with a subset of the user profile is provided. Alternatively, a software encoded with a subset of the user profile is provided. In this example, Able is profiled. The user profile includes: (i) Able's name, Able Smith; (ii) a set of I-D categories, including sports, food, and travel; (iii) a set of biometric information including a fingerprint; and (iv) a set of contact information including a telephone number. Able is provided mobile I-D device sub-system 104, which is secured using a biometric lock to which Able's fingerprint is the key. Able must place his finger over the biometric reader to use mobile I-D device sub-system 104. Mobile I-D device sub-system 104 is encoded with Able's name and unique user identification code.

Processing proceeds to step S265, where encounter mod 306 encounters a coded I-D tag or a coded I-D. The encounter occurs over a direct data communication or an indirect data communication. If the encounter occurs over an indirect data communication, the encounter does not occur until I-D matching sub-system 102 receives the subset of the I-D profile. In some embodiments of the present invention, the encounter occurs over one or more network protocols. Types of network protocols over which the encounter occurs include, but are not limited to: a radio frequency identification (RFID) network protocol; a radio frequency (RF) network protocol; an infrared (IR) network protocol; a cellular network protocol; and/or a wired network protocol. Upon encountering the coded I-D tag or the coded I-D, the I-D profile is retrieved from I-D profile storage 218 based on the subset of the I-D profile that was encoded. In some embodiments of the present invention, the user profile is retrieved from user profile storage 216 based on the subset of the user profile received from the mobile I-D device or the mobile I-D software. Alternatively, I-D matching sub-system 102 determines the user profile based on an input.

In some embodiments of the present invention, the mobile I-D device or mobile I-D software encounter the coded I-D tag or coded I-D and I-D matching sub-system 102 indirectly encounters the coded I-D tag or coded I-D through a data connection with the mobile I-D device or mobile I-D software. Alternatively, I-D matching sub-system 102 directly encounters the coded I-D tag or coded I-D through a direct data connection. In this example, Able walks past a billboard displaying the cruise advertisement of BCD Corp. bearing coded I-D tag sub-system 110. Coded I-D tag sub-system 110 transmits the unique I-D identification code over an active RFID network protocol. Mobile I-D device sub-system 104 includes a passive RFID reader that receives the unique I-D identification code from coded I-D tag sub-system 110. Mobile I-D device sub-system 104 transmits to I-D matching sub-system 102 the unique I-D identification code and Able's name. In this example, I-D matching sub-system 102 encounters coded I-D tag sub-system 110 upon receipt of the transmission from mobile I-D device sub-system 104. I-D matching sub-system 102 then retrieves the user profile corresponding to Able's name, Able Smith, and the I-D profile corresponding to unique I-D identification code, BCDCORP1.

Processing proceeds to step S270, where category match mod 308 determines that there exists a match between the set of I-D categories in the I-D profile and the set of I-D categories in the user profile. A match exists when a subset of the set of I-D categories in the I-D profile is also a subset of the set of I-D categories in the user profile. In some embodiments of the present invention, a match does not exist unless a plurality of the set of I-D categories in the I-D profile are also a plurality of the set of I-D categories in the user profile. In some embodiments of the present invention, a set of I-D categories are considered related, a related set of I-D categories. In those embodiments, a match exists when a member of the related set of I-D categories is a member of the set of I-D categories in the I-D profile and a different member of the related set of I-D categories is a member of the set of I-D categories in the user profile. If there is not a match, then processing terminates. In an alternative embodiment, an I-D content is returned containing no content. In yet another alternative embodiment, an I-D content is returned containing a message stating that no match was found. In the present example, the I-D profile includes “travel” as an I-D category, as does the user profile. Therefore a match exists.

Processing proceeds to step S275, where transmit information-distribution (I-D) mod 310 transmits the I-D content. In some embodiments of the present invention, the I-D content is transmitted directly to a user. Alternatively, the I-D content is transmitted indirectly to a user by first transmitting the I-D content to a mobile I-D device or a mobile I-D software. In some of these embodiments, the I-D content is transmitted when I-D matching sub-system 102 transmits the I-D content to a mobile I-D device or a mobile I-D software. In some embodiments of the present invention, an I-D content is stored in I-D profile storage 218 in a set of electronic file formats, including, but not limited to: (i) text; (ii) audio; (iii) image; (iv) video; (v) spreadsheet; (vi) webpage; (vii) slide show; (viii) script; (ix) source code; and/or (x) markup. In some embodiments of the present invention, the I-D content is stored as one electronic file format and is converted to a different electronic file format. In some of these embodiments, the I-D content is stored as a text file and is converted to an audio file using a speech synthesis module. In some of those embodiments, the speech synthesis module is contained within I-D matching sub-system 102. Alternatively, the speech synthesis module is contained within a mobile I-D device or a mobile I-D software. In some embodiments of the present invention, the I-D content includes tonal variations, selected based on a subset of the user profile. In some embodiments of the present invention, a set of metadata and/or a set of response options is also transmitted with the I-D content. In some embodiments of the present invention, the set of metadata and the set of response options are each saved as distinct files from the I-D content. In some embodiments of the present invention, the set of metadata and the set of response options are saved as different file types.

In this example, the set of metadata includes the format of the I-D content. In other embodiments of the present invention, the set of metadata includes, but is not limited to: (i) information about the I-D content; (ii) information about the set of information contained in the I-D profile; (iii) information about the manner of presentation of the I-D content; (iv) the file expiration date; (v) the format of the set of response options; (vi) the meaning of the set of response options; (vii) a set of I-D identification code corresponding to a set of related I-Ds; (viii) preferred method of I-D content presentation (e.g., video); and/or (ix) a time at which the I-D content is purged. In some embodiments of the present invention, transmission of the I-D content includes presentation of the I-D content to a user in a human understandable format. Alternatively, presentation of the I-D content to a user is not included in transmission of the I-D content. In some embodiments of the present invention, the time at which the I-D content is purged is a preset. In other embodiments of the present invention, the time at which the I-D content is purged is altered by the user. In some embodiments of the present invention, presentation of the I-D content to a user is done in a synchronous manner. Alternatively, the I-D content is presented to a user in an asynchronous manner, including, but not limited to: (i) on a set delay; (ii) on a variable delay; (iii) during a window of time set by the user; (iv) on demand by the user; (iv) in a first in-first out order; (v) in a last in-first out order; (vi) in a random or pseudo-random order; (vii) in order by expiration date; and/or (viii) based on the set of I-D categories.

In some embodiments of the present invention, after the I-D content is presented, the set of response options is presented. In some embodiments of the present invention, the set of response options include custom verbiage describing the set of response options. In some embodiments of the present invention, the set of response options are not exclusive selections. In some embodiments of the present invention, after the I-D content is presented, options are presented including whether to replay, delete, or store the I-D. In some embodiments of the present invention, the I-D is stored on the mobile I-D device. Alternatively, only the subset of the I-D profile is stored on the mobile I-D device. Alternatively, the user profile is updated to indicate storage of the I-D. In this example, the I-D content is stored in I-D profile storage 218 as a text file and I-D matching sub-system 102 contains a speech synthesis module. The I-D content is converted to an audio file prior to transmission from I-D matching sub-system 102 to mobile I-D device sub-system 104. Also transmitted by I-D matching sub-system 102 are the “contact” and “do not contact” response options. Mobile I-D device sub-system 104 presents I-D content in an asynchronous order, on demand by Able. Able demands presentation of the I-D content and mobile I-D device sub-system 104 presents the audio file. Subsequent to presenting Able with the I-D content, mobile I-D device sub-system 104 presents Able with the set of response options, “contact” and “do not contact.”

Processing proceeds to step S280, where receive response mod 312 receives the I-D response. The I-D response is received over a direct data communication or an indirect data communication. If the I-D response is received over an indirect data communication, the I-D response is not received until I-D matching sub-system 102 receives the I-D response. In some embodiments of the present invention, I-D matching sub-system 102 does not receive a response and processing terminates at step S275. Alternatively, I-D matching sub-system 102 does not receive a response and processing continues as if an option not to be contacted was received. In some embodiments of the present invention, response options are not presented to a user and processing terminates at step S275. Alternatively, response options are not presented and processing continues as if an option not to be contacted was received. In some embodiments of the present invention, the user profile is updated based on the response option selected. In some embodiments of the present invention, the I-D response includes a request for a set of related I-Ds. In this example, Able selects “contact” from the set of response options. Mobile I-D device sub-system 104 transmits Able's response, the “contact” response option, to I-D matching sub-system 102. In this example, I-D matching sub-system 102 receives the I-D response upon receipt of the transmission from mobile I-D device sub-system 104.

Processing terminates at step S285, where transmit response mod 314 transmits the I-D response. In some embodiments of the present invention, the I-D response is transmitted to the information distributor. In some embodiments of the present invention, when a user selects an option not to be contacted, I-D matching sub-system 102 does not transmit an I-D response. In this example, the set of metadata included the meaning of the set of response options, including that if the “contact” response option is selected, the set of contact information in the user profile would be transmitted to the information distributor. I-D matching sub-system 102 transmits to BCD Corp. the selection of the “contact” response option and Able's telephone number.

### III. Further Comments and/or Embodiments

Some embodiments of the present invention recognize the following facts, potential problems, and/or potential areas for improvement with respect to the current state of the art: (i) information distributors target a select group of individuals with each I-D; (ii) there are I-Ds that are over-inclusive, reaching individuals who are not members of the select group; (iii) there are I-Ds that are under-inclusive, failing to reach individuals who are members of the select group; and/or (iv) there are I-Ds that are both over-inclusive and under-inclusive.

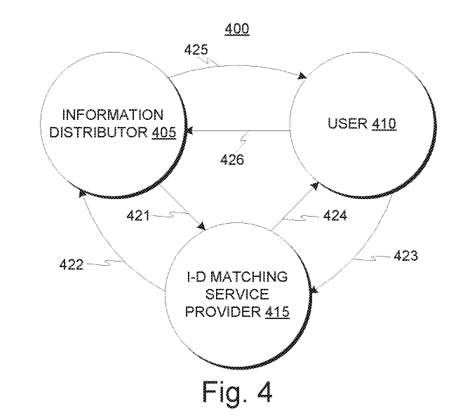

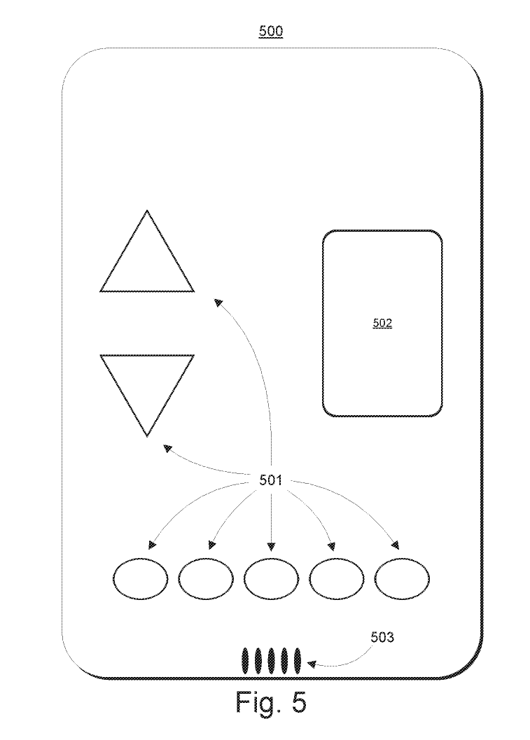

FIG. 4 shows data communication environment 400 depicting communication among three entities according to one embodiment of the present invention. The three entities are: information distributor 405; user 410; and information-distribution (I-D) matching service provider 415. Data communication among the three entities proceeds along data communication pathways 421, 422, 423, 424, 425, and 426. In some embodiments of the present invention, I-D matching service provider 415 uses the system portrayed as I-D matching sub-system 102 (FIG. 1).

Information distributor 405 transmits a set of information used to create an I-D profile along data communication pathway 421 to I-D matching service provider 415 (see step S255, FIG. 2). In some embodiments of the present invention, data communication pathway 421 is also used by information distributor 405 to modify the set of information used to create an I-D profile previously transmitted.

Information distributor 405 transmits a subset of the I-D profile to user 410 along data communication pathway 425 (see step S265, FIG. 2). Data communication pathway 425 is also used by information distributor 405 to contact user 410 after receipt of a “contact” response to a set of response options.

User 410 transmits a set of information used to create a user profile along data communication pathway 423 to I-D matching service provider 415 (see step S260, FIG. 2). In some embodiments of the present invention, data communication pathway 423 is also used by user 410 to modify the set of information used to create a user profile preciously transmitted. Data communication pathway 423 is also used by user 410 to transmit a subset of the I-D profile and a subset of the user profile to I-D matching service provider 415 (see step S265). User 410 also transmits an I-D response to I-D matching service provider 415 along data communication pathway 423 (see step S280, FIG. 2).

User 410 transmits an interaction along data communication pathway 426 to information distributor 405. The interaction is in response to a contact from information distributor 405 along data communication pathway 425.

I-D matching service provider 415 transmits a set of coded I-D tags to information distributor 405 along data communication pathway 422 (see step S255). Alternatively, I-D matching service provider 415 provides another method of encoding an I-D to information distributor 405 along data communication pathway 422. Additionally, I-D matching service provider 415 transmits an I-D response received from user 410 to information distributor 405 along data communication pathway 422 (see step S285, FIG. 2).

I-D matching service provider 415 transmits a mobile I-D device to user 410 along data communication pathway 424 (see step S260). Alternatively, I-D matching service provider 415 transmits a mobile I-D software to user 410 along data communication pathway 424. Additionally, I-D matching service provider 415 transmits an I-D content to user 410 along data communication pathway 424. Alternatively, a set of metadata and/or a set of response options is also transmitted along data communication pathway 424 to user 410.

FIG. 5 shows apparatus 500 depicting one embodiment of the mobile I-D device. This depiction of apparatus 500 is designed as an easy-to-use device that is specifically designed for an improved experience for a visually impaired user. The internal workings of apparatus 500 allow for communication with an information distributor and an I-D matching service provider, as depicted in FIG. 4. Additionally, the device includes a number of software, firmware, and hardware components that allow for a robust interaction with I-Ds in audio format.

Visible features of apparatus 500 include: set of buttons 501; biometric scanner 502; audio input/output 503. In some embodiments of the present invention, set of buttons 501 is used to select a response option or to navigate through menus. In some embodiments of the present invention, set of buttons 501 is also used to save an I-D content to a memory within apparatus 500. In some embodiments of the present invention, biometric scanner 502 is used to match a user with a user profile. Additionally, in some embodiments of the present invention, biometric scanner 502 is used to secure apparatus 500. In some embodiments of the present invention, audio input/output 503 is used to present an I-D content to a user. Alternatively, audio input/output 503 is used to receive audio input from a user.

Some embodiments of the present invention may include one, or more, of the following features, characteristics, and/or advantages: (i) assisting an information distributor in increasing the exposure of an I-D to individuals who are members of a select audience group; (ii) assisting an information distributor in decreasing the exposure of an I-D to individuals who are not members of a select audience group; (iii) increasing an individual's awareness of goods and services in which the individual is interested, for an individual who is a member of a select audience group; and/or (iv) decreasing an individual's exposure to an I-D that is not related to goods or services in which the individual is interested, for an individual who is not a member of a select audience group.

Some embodiments of the present invention may include one, or more, of the following features, characteristics, and/or advantages: (i) tailoring a match between an information distributor and a select audience group; (ii) linking an information distributor to a select audience group through a third-party I-D matching service provider; (iii) allowing individuals to interact with an I-D and/or an information distributor; (iv) converting I-Ds from one format to a different format; (v) using a speech synthesis module; (vi) receiving an I-D response from an individual, based on an interest in the I-D; (vii) mediating between an information distributor and a user; (viii) profiling and categorizing I-Ds; and/or (ix) comparing I-D categories to user interests.

Some embodiments of the present invention may include one, or more, of the following features, characteristics, and/or advantages: (i) an I-D response may be transmitted to an information distributor; (ii) the interests of a user with respect to I-D categories are taken into account; (iii) a centralized method of matching an I-D to an individual in the select audience group; (iv) a loosely coupled communication among an I-D matching service provider, an information distributor, and a user; (v) an individual chooses whether to be contacted further by an information distributor; (vi) a user may determine when to interact with a set of I-Ds; (vii) a user may update the user profile; and/or (viii) an information distributor may update the I-D profile.

Some embodiments of the present invention may include one, or more, of the following features, characteristics, and/or advantages: (i) determining if a user's set of I-D categories aligns with a set of I-D categories for an I-D; (ii) presenting I-Ds to a user, through a direct or an indirect data connection, in a human understandable format; (iii) communicating with a mobile I-D device or a mobile I-D software through a wireless network protocol; (iv) encountering a coded I-D tag or a coded I-D; and/or (v) converting a text file into an audio file using a speech synthesis module.

Some embodiments of the present invention may include one, or more, of the following features, characteristics, and/or advantages: (i) modifying a mobile I-D device be specifically designed for an improved experience for a visually impaired user; (ii) using a multitier communication network among multiple parties; (iii) orchestrating and mediating communication between a user and an information distributor; (iv) allowing users to interact with a variety of I-Ds; (v) allowing users to manage and sort through a set of I-Ds; (vi) providing a mechanism for a user to interact with an I-D on the user's schedule; (vii) allowing for interactive responses to an I-D.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

And/or: inclusive or; for example, A, B “and/or” C means that at least one of A or B or C is true and applicable.

Including/include/includes: unless otherwise explicitly noted, means “including, but not necessarily limited to.”

User/subscriber: includes, but is not necessarily limited to, the following: (i) a single individual human; (ii) an artificial intelligence entity with sufficient intelligence to act as a user or subscriber; and/or (iii) a group of related users or subscribers.

Electrically Connected: means either directly electrically connected, or indirectly electrically connected, such that intervening elements are present; an electrical connection may include, but need not be limited to, elements such as capacitors, inductors, transformers, vacuum tubes, and the like.

Mechanically connected: Includes both direct mechanical connections, and indirect mechanical connections made through intermediate components; includes rigid mechanical connections as well as mechanical connection that allows for relative motion between the mechanically connected components; includes, but is not limited, to welded connections, solder connections, connections by fasteners (for example, nails, bolts, screws, nuts, hook-and-loop fasteners, knots, rivets, quick-release connections, latches, and/or magnetic connections), force fit connections, friction fit connections, connections secured by engagement caused by gravitational forces, pivoting or rotatable connections, and/or slidable mechanical connections.

Data communication: any sort of data communication scheme now known or to be developed in the future, including wireless communication, wired communication, and communication routes that have wireless and wired portions; data communication is not necessarily limited to: (i) direct data communication; (ii) indirect data communication; and/or (iii) data communication where the format, packetization status, medium, encryption status, and/or protocol remains constant over the entire course of the data communication.

Receive/provide/send/input/output/report: unless otherwise explicitly specified, these words should not be taken to imply: (i) any particular degree of directness with respect to the relationship between their objects and subjects; and/or (ii) absence of intermediate components, actions, and/or things interposed between their objects and subjects.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory, or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A method comprising:
creating a user profile, including at least:
a first set of advertisement categories, wherein the first set of advertisement categories is selected, by a user, from a list consisting of:
sports,
entertainment,
travel, and
food, and
a set of biometric information for the user, wherein the set of biometric information includes a user fingerprint;
creating an advertisement profile for a first advertisement, including at least:
a second set of advertisement categories, wherein the second set of advertisement categories is selected from the list consisting of:
sports,
entertainment,
travel, and
food,
an advertisement content,
an expiration date for the advertisement content, and
a set of response options, wherein the set of response options includes:
a first option to receive additional content, and
a second option not to receive additional content,
wherein the second set of advertisement categories is based, at least in part, on the advertisement content;
encoding a subset of the advertisement profile onto a radio frequency identification tag;
receiving the subset of the advertisement profile from a user device over a wireless network protocol, wherein the user device received the subset of the advertisement profile from the radio frequency identification tag;
receiving a fingerprint from the user device over the wireless network protocol, wherein the user device received the fingerprint from the user as an input;
determining the fingerprint received from the user device matches the user fingerprint in the user profile;
determining the subset of the advertisement profile received from the user device matches the advertisement profile;
confirming at least a category in the first set of advertisement categories matches a category in the second set of advertisement categories;
using a speech synthesis module to present the advertisement content and the set of response options to the user in a human understandable format by use of an asynchronous delay, in a first in-first out order during a window of time set by the user in the user profile, wherein the first in-first out order is further prioritized based on the expiration date;
receiving an advertisement response to the set of response options from the user device over a wireless network protocol, wherein the advertisement response is the first option to receive additional content; and
transmitting the advertisement response and the user profile to an advertiser;
wherein the user device is a user interface assembly including:
a processor set;
a biometric reader electrically connected to the processor set, wherein the biometric reader includes a fingerprint scanner;
a computer readable storage medium:
electrically connected to the processor set, and
on which is stored a subset of the user profile;
an input/output interface sub-assembly:
electrically connected to the processor set, and
which includes the speech synthesis module;
a wireless network communication sub-assembly:
electrically connected to the processor set, and
capable of transmitting the advertisement profile, the fingerprint, and the advertisement response; and
a radio frequency identification communication sub-assembly:
electrically connected to the processor set, and
in communication with the radio frequency identification tag.
